(19) United States
(12) Patent Application Publication
(10) Pub. No.: US 2025/0328363 A1
(43) Pub. Date: Oct. 23, 2025

(54) SYSTEM AND METHOD FOR PROVIDING A GRAPHICAL USER INTERFACE

(71) Applicant: The Toronto-Dominion Bank, Toronto (CA)

(72) Inventors: Carlin POHL, Regina (CA); Chantal LAPLANTE, Regina (CA); Thomas Nicholas YURKIW, Toronto (CA)

(73) Assignee: The Toronto-Dominion Bank, Toronto (CA)

(21) Appl. No.: 18/643,132

(22) Filed: Apr. 23, 2024

(51) Int. Cl. G06F 9/451; G06Q 40/06

(52) U.S. Cl. CPC G06F 9/451; G06Q 40/06

(57) ABSTRACT

A server computer system comprises a communications module; at least one processor coupled to the communications module; and a memory coupled to the at least one processor and storing processor-executable instructions which, when executed by the at least one processor, configure the at least one processor to obtain data associated with a plurality of assets; group the assets into one or more asset buckets; within at least one of the asset buckets, identify at least one representative asset based at least on stored selection criteria; obtain at least one image associated with the at least one representative asset; and send, via the communications module and to a computing device, an asset summary interface that includes the at least one image associated with the at least one representative asset. The plurality of assets may include one or more assets generated using an artificial intelligence engine trained on asset data.

### TECHNICAL FIELD

The present application relates to systems and methods for providing a graphical user interface.

### BACKGROUND

Graphical user interfaces and other such interfaces can result in an unnecessary waste in bandwidth and computer processing power as user interaction with the graphical user interface results in data exchanges between the computing device displaying the graphical user interface and the computer server providing the graphical user interface.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computer system;

FIG. 3 shows a simplified organization of software components stored in a memory of the example computer system of FIG. 2;

FIG. 4 is a flowchart showing operations performed by a server in providing a transfer record summary interface according to an embodiment;

FIG. 5 is an example asset summary interface according to an embodiment;

FIG. 6 is an example display of a representative asset according to an embodiment;

FIG. 7 is another example asset summary interface according to an embodiment;

FIG. 8 is an example cluster forming part of the example asset summary interface of FIG. 7 according to an embodiment;

FIG. 9 is another example cluster forming part of the example asset summary interface of FIG. 7 according to an embodiment; and

FIG. 10 is zoomed-in view of a portion of a static image forming part of the example asset summary interface of FIG. 7 according to an embodiment.

Like reference numerals are used in the drawings to denote like elements and features.

### DETAILED DESCRIPTION OF VARIOUS EMBODIMENTS

Accordingly, in one aspect there is provided a server computer system comprising a communications module; at least one processor coupled to the communications module; and a memory coupled to the at least one processor and storing processor-executable instructions which, when executed by the at least one processor, configure the at least one processor to obtain data associated with a plurality of assets; group the assets into one or more asset buckets; within at least one of the asset buckets, identify at least one representative asset based at least on stored selection criteria; obtain at least one image associated with the at least one representative asset; and send, via the communications module and to a computing device, an asset summary interface that includes the at least one image associated with the at least one representative asset.

In one or more embodiments, when obtaining the at least one image associated with the at least one representative asset, the processor-executable instructions which, when executed by the at least one processor, configure the at least one processor to generate an application programming interface request (API) for obtaining the at least one image associated with the at least one representative asset; send, via the communications module and to an API endpoint, the API request for the at least one image associated with the at least one representative asset; and receive, via the communications module and from the API endpoint, the at least one image associated with the at least one representative asset.

In one or more embodiments, the API request defines at least one parameter for obtaining the at least one image associated with the at least one representative asset.

In one or more embodiments, the at least one parameter includes at least one of a location, heading, pitch or image size.

In one or more embodiments, the processor-executable instructions which, when executed by the at least one processor, configure the at least one processor to consult a database to retrieve the at least one parameter for obtaining the at least one image associated with the at least one representative asset, the database maintaining data records that store the data associated with the plurality of assets and associating each asset with at least one parameter for obtaining the at least one image associated with the asset.

In one or more embodiments, the processor-executable instructions which, when executed by the at least one processor, configure the at least one processor to calculate at least one metric for each asset bucket; and update the asset summary interface to include at least one interface element associated with the calculated at least one metric.

In one or more embodiments, a size of the at least one interface element displayed on the asset summary interface is based on the calculated at least one metric.

In one or more embodiments, the asset summary interface includes a static image and the processor-executable instructions which, when executed by the at least one processor, configure the at least one processor to calculate at least one metric for each asset bucket; and overlay at least one interface element associated with the calculated at least one metric on the static image.

In one or more embodiments, the asset summary interface displays at least one indication of each asset, the at least one indication displayed in a particular size based on at least one metric of the asset and in a particular format based on the asset bucket the asset is grouped into.

In one or more embodiments, the processor-executable instructions which, when executed by the at least one processor, configure the at least one processor to engage a normalization engine to normalize the obtained data associated with the plurality of assets into a particular format.

According to another aspect there is provided a computer-implemented method comprising obtaining data associated with a plurality of assets; grouping the assets into one or more asset buckets; within at least one of the asset buckets, identifying at least one representative asset based at least on stored selection criteria; obtaining at least one image associated with the at least one representative asset; and sending, via a communications module and to a computing device, an asset summary interface that includes the at least one image associated with the at least one representative asset.

In one or more embodiments, when obtaining the at least one image associated with the at least one representative asset, the method further comprises generating an application programming interface request (API) for obtaining the at least one image associated with the at least one representative asset; sending, via the communications module and to an API endpoint, the API request for the at least one image associated with the at least one representative asset; and receiving, via the communications module and from the API endpoint, the at least one image associated with the at least one representative asset.

In one or more embodiments, the API request defines at least one parameter for obtaining the at least one image associated with the at least one representative asset.

In one or more embodiments, the at least one parameter includes at least one of a location, heading, pitch or image size.

In one or more embodiments, the method further comprises consulting a database to retrieve the at least one parameter for obtaining the at least one image associated with the at least one representative asset, the database maintaining data records that store the data associated with the plurality of assets and associating each asset with the at least one parameter for obtaining the at least one image associated with the asset.

In one or more embodiments, the method further comprises calculating at least one metric for each asset bucket; and updating the asset summary interface to include at least one interface element associated with the calculated at least one metric.

In one or more embodiments, a size of the at least one interface element displayed on the asset summary interface is based on the calculated at least one metric.

In one or more embodiments, the asset summary interface includes a static image and the method further comprises calculating at least one metric for each asset bucket; and overlaying at least one interface element associated with the calculated at least one metric on the static image.

In one or more embodiments, the asset summary interface displays at least one indication of each asset, the at least one indication displayed in a particular size based on at least one metric of the asset and in a particular format based on the asset bucket the asset is grouped into.

According to another aspect there is provided a non-transitory computer readable medium having stored thereon processor-executable instructions which, when executed by at least one processor, configure the at least one processor to obtain data associated with a plurality of assets; group the assets into one or more asset buckets; within at least one of the asset buckets, identify at least one representative asset based at least on stored selection criteria; obtain at least one image associated with the at least one representative asset; and send, via a communications module and to a computing device, an asset summary interface that includes the at least one image associated with the at least one representative asset.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

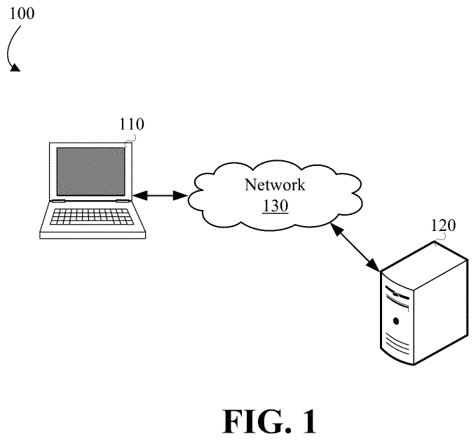

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

Although not shown in FIG. 1, in one or more embodiments the server computer system 120 may communicate with one or more third party servers and this may be done via the network 130. In one or more embodiments, the server computer system 120 may include an application configured for secure communications with one or more application programming interfaces (APIs) and the APIs may be associated with the one or more third party servers.

The server computer system 120 may maintain a database that may store data associated with a plurality of assets. For example, as will be described, the database may maintain data records that store the data associated with the plurality of assets and may associate each asset with at least one parameter for obtaining at least one image associated with the asset.

As will be described in more detail below, the server computer system 120 may be configured to provide an asset summary interface to the computing device 110.

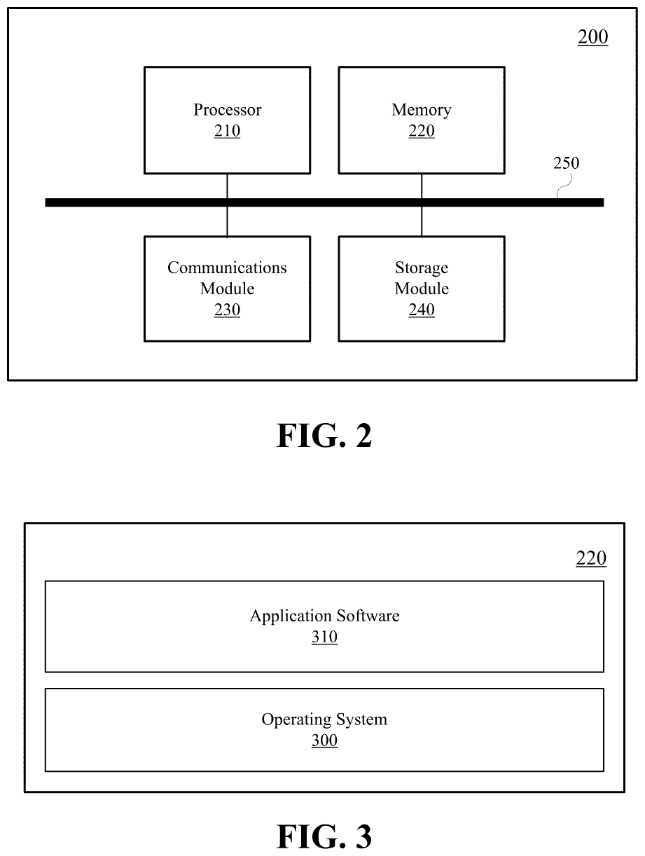

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application 310.

The operating system 300 is software. The operating system 300 allows the application 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application 310 adapts the computer system 200, in combination with the operating system 300, to operate as a device for performing a specific function. For example, the application 310 may cooperate with the operating system 300 to adapt a suitable embodiment of the example computer system 200 to operate as the computing device 110 and/or the server computer system 120.

While a single application 310 is illustrated in FIG. 3, in operation the memory 220 may include more than one application 310 and different applications 310 may perform different operations. For example, in at least some embodiments in which the computer system 200 is functioning as the computing device 110, the applications 310 may include a web browser, which may also be referred to as an Internet browser. In at least some such embodiments, the server computer system 120 may be a web server that may serve one or more of the interfaces described herein. The web server may cooperate with the web browser and may serve as an interface when the interface is requested through the web browser.

By way of further example, in at least some embodiments in which the computer system 200 functions as the server computer system 120, the applications 310 may include an application configured for secure communications with one or more application programming interfaces (APIs). The application may include, for example, a Hypertext Transfer Protocol (HTTP) client. Through the application, the server computer system 120 may be configured to communicate API requests such as for example GET requests to one or more API endpoints.

By way of further example, in at least some embodiments in which the computer system 200 functions as the computing device 110, the applications 310 may include an asset summary application. The asset summary application may be configured for secure communications with the server computer system 120 and may display one or more graphical user interfaces such as for example an asset summary interface provided by the server computer system 120.

Within the asset summary application, the server computer system 120 may be configured to generate one or more graphical user interfaces and provide them to the computing device 110 for display thereon. As will be described, the one or more graphical user interfaces may display interface elements generated based on asset data collected by the server computer system 120 from one or more third party servers. The server computer system 120 may generate the graphical user interfaces in a manner that reduces the reliance of computing resources such as for example computer memory.

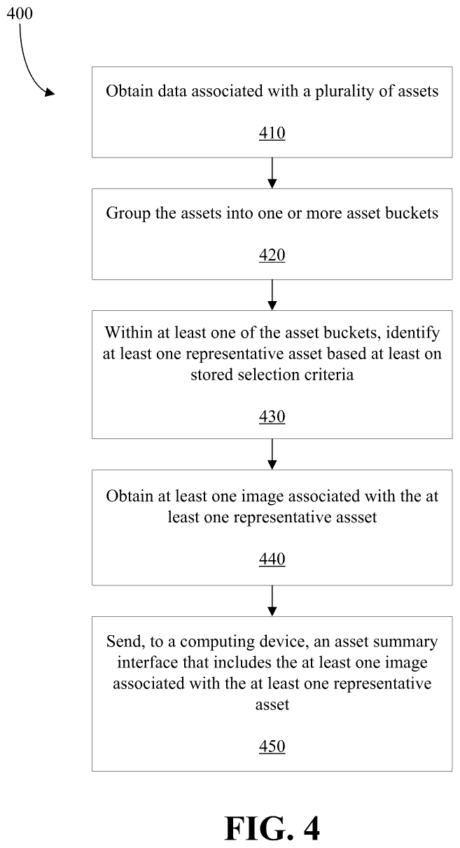

Reference is made to FIG. 4, which illustrates, in flowchart form, a method 400 for providing a graphical user interface. The method 400 may be implemented by a computing device having suitable processor-executable instructions for causing the computing device to carry out the described operations. The method 400 may be implemented, in whole or in part, by the server computer system 120.

The method 400 includes obtaining data associated with a plurality of assets (step 410).

The server computer system 120 may obtain a list that includes the plurality of assets. For example, within the asset summary application, a digital file may be uploaded or otherwise provided that includes the list of the plurality of assets. The digital file may include, for example, a Microsoft™ Excel™ file. As another example, the server computer system 120 may obtain the list that includes the plurality of assets. For example, the plurality of assets may include assets owned or partially owned within one or more real estate funds. The server computer system 120 may present a graphical user interface for display on the computing device 110 that may include one or more interface elements for selecting one or more real estate funds. In response to selection of one or more of the real estate funds, the server computer system 120 may retrieve the list that includes the plurality of assets from the database or may communicate with one or more third party servers to obtain the list that includes the plurality of assets. The list of the plurality of assets may identify, for example, a physical address for each asset. Other information may include asset type. In one or more embodiments, the asset type may include one of office, retail, industrial, commercial, residential or other. It will be appreciated that the list may include metadata and/or metatags for each asset and the metadata and/or metatags may store information related to the asset.

Once the list of the plurality of assets is obtained, the server computer system 120 may perform operations to obtain data for each asset. In addition to the physical address and asset type, the data for each asset may include asset statistics such as for example the Gross Asset Value (GAV), the number of units in the asset, the size of the asset such as for example the square footage of the asset, the occupancy percentage of the asset, an indicator as to whether or not the asset is under development or renovation, the percentage of the asset owned, the percentage of the GAV owned, etc.

To obtain the data associated with an asset, in one or more embodiments, the server computer system 120 may identify one or more APIs and/or third party servers to obtain the data from.

In one or more embodiments, the server computer system 120 may maintain a database that may be consulted to identify the one or more APIs and/or third party servers to obtain the data from. For example, the database may maintain a lookup table that may identify one or more APIs and/or one or more third party servers. The lookup table may associate the one or more APIs and/or one or more third party servers to different asset types, asset locations, etc. For example, a first API may be associated with a first asset type and a second API may be associated with a second asset type. As another example, a first API may be associated with a first asset type in a first asset location and a second API may be associated with the first asset type in a second asset location.

In one specific example, a first API may be associated with the asset type commercial and the asset location of the United States of America. A second API may be associated with the asset type commercial and the asset location of Canada. For a particular asset in the list of assets, the server computer system 120 may analyze the physical address of the particular asset to identify a country of the particular asset and may retrieve the asset type. The country may be Canada and the asset type may be commercial. As such, the server computer system 120 may consult the lookup table to identify the second API and may perform operations to obtain data from the second API.

It will be appreciated that the lookup table may identify multiple APIs and/or third party servers. For example, for each asset type, multiple APIs and/or third party servers may be identified where each API or third party server may be engaged to obtain a particular type of data therefrom.

The lookup table may store other types of information that may be used to obtain the data. For example, the lookup table may define or otherwise identify a format for an API request that is to be sent to a particular API to request the data therefrom. The server computer system 120 may retrieve the format for the API request from the lookup table and may populate the API request automatically using, for example, the physical address of the asset. In this manner, the server computer system 120 may automatically generate API requests for each asset in the list of assets without human intervention. Similarly, the server computer system 120 may generate requests that are to be sent directly to the one or more third party servers.

To obtain data from an API, the server computer system 120 may engage an application configured for secure communications with an API endpoint. In one or more embodiments, the same application may be engaged for all API requests. However, in one or more other embodiments, the application to be engaged may be identified, for example, using the lookup table. For example, a first application may be engaged for a first API and a second application may be engaged for a second API.

The server computer system 120 may generate one or more API requests for obtaining the data associated with the asset from the API. The one or more API requests may include, for example, one or more GET requests. As mentioned, in one or more embodiments, the format of the one or more API requests may be retrieved from the lookup table.

Each API request may define at least one parameter for obtaining the data associated with the asset. The at least one parameter may include the physical address of the asset. The at least one parameter may include additional information such as for example the type of data requested and/or the asset type.

Each API request may be communicated to an API endpoint. The API endpoint may be associated with a third party server that may provide the requested data.

In response to receiving the API request, the third party servers may perform operations to retrieve the requested data and may generate an API response. The API response includes the requested data. The server computer system 120 may receive the API response and in this manner the server computer system 120 may obtain the data for the asset.

Of course, as mentioned, at least some of the data may be received directly from one or more third party servers without the use of an API. For example, the server computer system 120 may communicate a request for data directly to the one or more third party servers via the network and the server computer system 120 may similarly receive the data directly from the one or more third party servers.

The data obtained from via the one or more APIs and/or via the one or more third party servers may be in different formats, structures and/or conventions. For example, different APIs may represent similar data differently. As such, the server computer system 120 may engage a normalization engine to normalize the obtained data associated with the plurality of assets into a particular format.

The normalization engine may be trained to normalize data for each API and/or third party server. For example, during a training process, response data from each API and/or third party server may be reviewed to identify common data elements that represent the same or similar information. This may include field names, data types, structures, etc.

A unified data schema may be defined that accommodates all of the identified common data elements. The field names, data types, and relationships between them may be defined. The schema may be used as the blueprint for normalizing the data.

For each API or third party server, the response data from each API or third party server may be mapped to the fields in the unified data schema. This may involve renaming fields, converting data types, or otherwise restructuring the data to fit the schema.

In one or more embodiments, one or more of the APIs or third party servers may have unique data elements or structures that may not align with the unified data schema. During the training process, the normalization engine may be trained to handle these variations by creating additional fields, transforming the data, or discarding non-essential information.

Training of the normalization engine may additionally include generating or defining data transformation logic. The data transformation logic may include processor-executable computer program code or scripts to transform the data from each API response into the standardized format defined by the unified data schema. Programming languages such as for example Python™, JavaScript™, etc. may be used.

Through training of the normalization engine, data collected or otherwise obtained from the APIs or third party servers may be automatically performed by the normalization engine and this may be done each time data is received or obtained. For example, the normalization engine may identify which API or third party server has provided the data and in response the normalization engine may perform operations to transform the data into the unified data schema.

The obtained data may be stored in the database. The server computer system 120 may additionally utilize the obtained data to calculate or otherwise determine one or more additional asset statistics for one or more of the assets. For example, the server computer system may calculate a weight percentage that identifies what percentage of an entire asset portfolio a particular asset makes up. For example, a first asset may have a GAV $110M and may be within an asset portfolio worth $22B. As such, the asset may be determined to make up 0.5% of the asset portfolio.

The method 400 includes grouping the assets into one or more asset buckets (step 420).

The server computer system 120 groups the assets into one or more asset buckets. The assets may be grouped into asset buckets based on a number of factors such as for example region, country, asset type, size, year of purchase, etc. For example, the server computer system 120 may group all assets from a certain region or country into an asset bucket associated with the region or country. It will be appreciated that each asset may be included in more than one asset bucket. For example, an asset may be grouped into a first asset bucket associated with a particular country and may be grouped into a second asset bucket associated with a particular asset type. Further, sub-buckets may be defined within each asset bucket. For example, a first asset bucket may be associated with a particular country. Within the first asset bucket, multiple sub-buckets may be defined where each sub-bucket is associated with a particular asset type.

Once the assets have been grouped into one or more asset buckets, the server computer system 120 may calculate statistics for each asset bucket or sub-bucket. For example, a first asset bucket may be associated with the asset type “office” and as such all assets grouped into the first asset bucket may be of the asset type “office”. The server computer system 120 may calculate one or more statistics for the first asset bucket which may include, for example, a count of assets grouped into the first asset bucket, the GAV total for the first asset bucket, a weight percentage which may identify what percentage of the entire asset portfolio the first asset bucket makes up, etc.

The method 400 includes, within at least one of the asset buckets, identifying at least one representative asset based at least on stored selection criteria (step 430).

In one or more embodiments, identify at least one representative asset may include analyzing the metadata or metatags of the assets within the at least one of the asset bucket and identifying the at least one representative asset based on the metadata or metatags associated therewith. In this manner, metadata or metatags of the assets may be leveraged to identify the at least one representative asset.

The stored selection criteria may be based on one or more statistics. For example, the stored selection criteria may define that the asset with the largest GAV is to be identified. In this example, the assets may be grouped into asset buckets based on asset type. All assets within the same bucket may be compared and the asset with the largest GAV may be identified as the at least one representative asset for that particular bucket. As another example, the stored selection criteria may define that the asset with the largest square footage may be identified as the at least one representative asset for that particular bucket.

In one or more embodiments, multiple assets may be identified for a particular asset bucket. For example, the three assets that have the largest GAV may be identified for a particular asset bucket.

In one or more embodiments, the at least one representative asset may be generated by the server computer system 120. For example, in one or more embodiments, the server computer system 120 may ingest or otherwise obtain metadata or metatags associated with one or more of the assets in a particular asset bucket and may identify or otherwise generate a representative asset using at least the metadata or metatags.

The method 400 includes obtaining at least one image associated with the at least one representative asset (step 440).

In one or more embodiments, the server computer system 120 may engage an API to obtain the at least one image associated with the at least one representative asset. For example, the server computer system may engage an application configured for secure communications with an API endpoint. The API endpoint may be a Google™ Streetview API.

The server computer system 120 may generate an API requests for obtaining the at least one image associated with the at least one representative asset. For example, the server computer system 120 may define a GET request that defines at least one parameter for obtaining the at least one image associated with the at least one representative asset. The at least one parameter may include, for example, a location, heading, pitch or image size.

The location may include a physical address of the at least one representative asset or may include coordinates such as for example the latitude and longitude of the at least one representative asset. It will be appreciated that in embodiments where the physical address of the at least one representative asset are known, the server computer system 120 may communicate with one or more APIs or third party servers to determine the coordinates of the at least one representative asset.

The heading may define a camera direction for obtaining the image of the at least one representative asset. The heading may be defined as a number. For example, the heading may be defined in degrees relative to true north. True north may be 0 degrees, east may be 90 degrees, south may be 180 degrees, and west may be 270 degrees. The heading may be defined such that the camera heading is directed at a desired viewpoint of the asset.

The pitch may define an angle of the camera for obtaining the image of the at least one representative asset. For example, the pitch may define an up or down angle of the camera. The pitch may be defined as a number and may be between 90 degrees (directly upwards) to negative 90 degrees (directly downwards). The pitch may be defined such that the camera pitch is directed at a desired angle to the asset.

The image size may define the size of the image of the at least one representative asset. The image size may be requested in pixels.

The one or more API requests may include, for example, one or more GET requests. As mentioned, in one or more embodiments, the format of the one or more API requests may be retrieved from the lookup table.

The at least one parameter for obtaining the image of the at least one representative asset may be predefined or otherwise stored in the database. For example, during a configuration process, the server computer system 120 may obtain a satellite image of the at least one representative asset and a particular view or angle may be defined for viewing the asset. The particular view or angle may be used to define parameters such as for example the heading and/or pitch.

The parameters may be stored in the database such that the database associates each asset with at least one parameter for obtaining the at least one image associated with the asset. In this manner, the at least one parameter for obtaining the at least one image associated with the asset may be retrieved by the server computer system 120 and this may be used to automatically generate the API request.

The API request, which may include a GET request that includes the at least one parameter, is communicated to the API endpoint. In response to receiving the API request, the API may perform operations to obtain the at least one image of the at least one representative asset in accordance with the requested parameters and to communicate the at least one image to the server computer system 120. The server computer system 120 may receive, from the API endpoint, the at least one image associated with the at least one representative asset.

The method 400 includes sending, to a computing device, an asset summary interface that includes the at least one image associated with the at least one representative asset (step 450).

The server computer system 120 generates an asset summary interface that includes the at least one image associated with the at least one representative asset. The asset summary interface may be provided for display on the computing device 110.

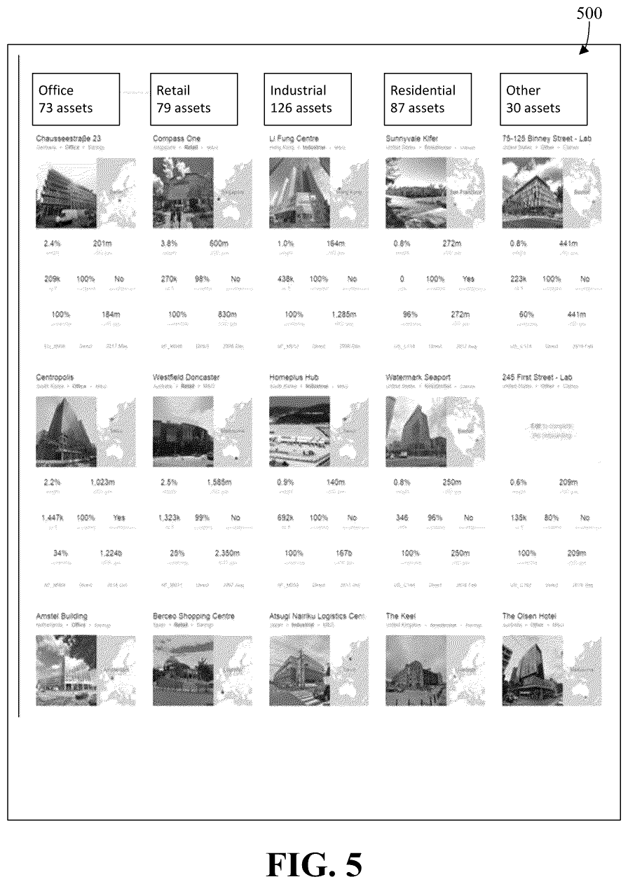

An example asset summary interface 500 is shown in FIG. 5. In this example, the assets are grouped into asset buckets by asset type which, as can be seen, includes office, retail, industrial, residential, and other. On the asset summary interface 500, for each asset bucket, three (3) representative assets are displayed and this may be based on an identification of the top three (3) assets by weight percentage.

As mentioned, the server computer system 120 may calculate at least one metric for each asset bucket. The server computer system 120 may calculate a count of assets in each asset bucket and the asset summary interface 500 may be updated to display the total count of assets in each asset bucket as shown in FIG. 5.

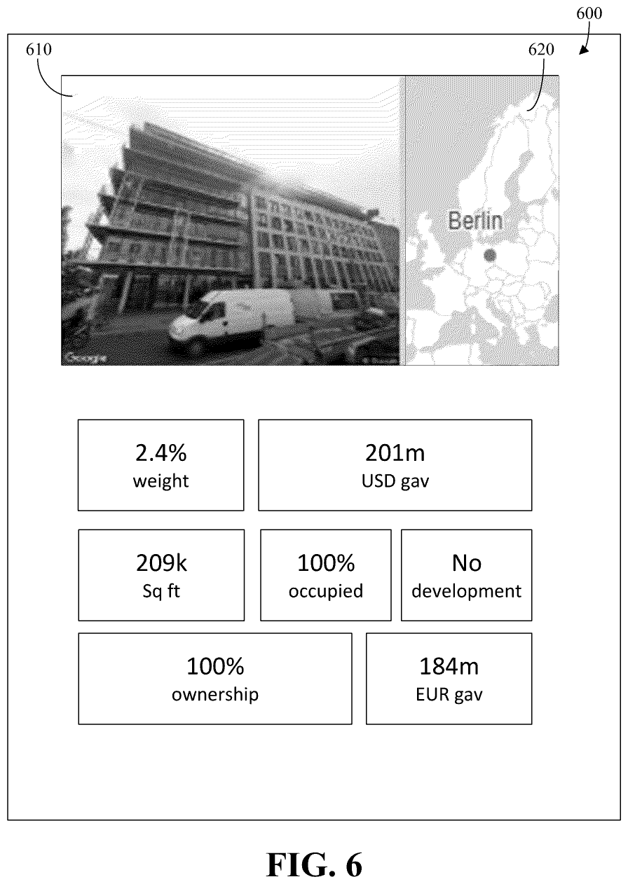

The display of each representative asset includes an image associated with the representative asset, a map view showing an approximate physical location of the representative asset, and statistics relating to the representative asset. An example display 600 of a representative asset is shown for illustrative purposes in FIG. 6. As can be seen, the display 600 includes an image 610 associated with the representative asset. The image 610 may be obtained in manners similar to that described herein with reference to step 440. The display 600 includes a map view 620 that shows an approximate physical location of the representative asset. The display 600 includes statistics relating to the representative asset which, in this example, include a weight percentage, the GAV of the asset in USD, the size of the asset, the occupancy percentage of the asset, an indicator as to whether or not the asset is under development or renovation, the percentage of the asset owned, and the GAV of the asset in EUR.

Referring back to FIG. 5, the asset summary interface 500 may provide a simple visual representation of assets owned within one or more real estate funds. By selecting representative assets for each asset bucket and obtaining an image for each representative asset, a visual representation of the representative assets may be presented. Further, by communicating with APIs and third party servers and by filtering obtained data through the normalization engine, the server computer system 120 is able to present consistent, accurate and up-to-date data.

In manners described herein, by storing the parameters for the at least one image of the at least one representative asset, the server computer system 120 is able to retrieve the parameters from the database and generate an API request that includes the parameters and this may be done to eliminate any requirements for image processing. Put another way, the server computer system 120 is able to offload any image processing requirements to the third party server associated with the API endpoint and this may free up computing resources such as memory and processing at the server computer system 120.

In manners described herein, the server computer system 120 may only obtain images associated with representative assets. The server computer system 120 does not obtain images for other assets within the asset bucket unless requested to do so. As such, the server computer system 120 does not unnecessarily obtain images for assets not identified as representative and this may free up computing resources such as memory at the server computer system 120.

The asset summary interface may include interface elements for updating or adjusting a view thereof. For example, a user may wish to view all assets within an asset bucket. As such, a selectable option may be presented on the asset summary interface that may allow a user to select one or more asset buckets and in response, the asset summary interface may be updated to display all of the assets within the asset bucket.

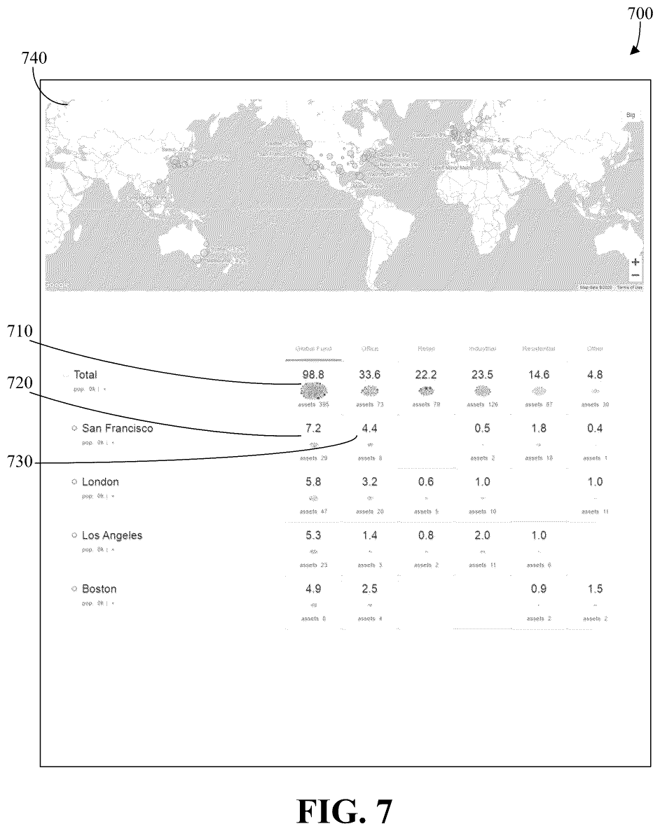

The server computer system 120 may present the data associated with the plurality of assets in one or more different manners. For example, another asset summary interface 700 is shown in FIG. 7.

In this example, the assets may be grouped into asset buckets by region and by asset type. Within each asset bucket, the assets may be further grouped into sub-buckets. For example, the assets may be grouped into asset buckets by region and may be grouped into sub-buckets by asset type. Further, the assets may be grouped into asset buckets by asset type and may be grouped into sub-buckets by region. The server computer system 120 may calculate one or more statistics for each bucket and for each sub-bucket and may update the asset summary interface 700 to display interface elements associated with the calculated one or more statistics.

As shown in FIG. 7, the asset summary interface 700 displays a chart that displays a total GAV for all assets and breaks down the total GAV by asset type. The asset summary interface 700 also displays a total GAV for the top four (4) regions and breaks down the GAV for each region by asset type.

The server computer system 120 may generate an indication of each asset that is included in the data currently being displayed. The size of the indication of each asset may be based on at least one metric of the asset. Further, the format of the indication may be based on what asset bucket the asset is grouped into.

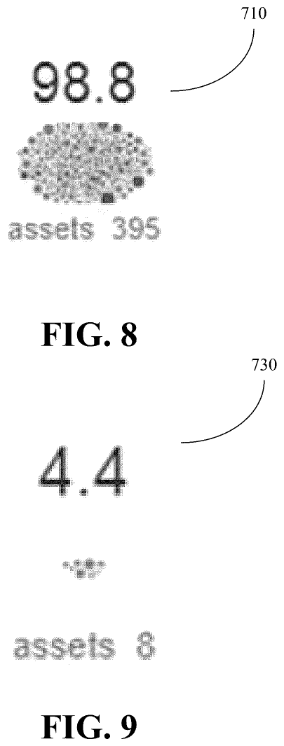

The asset summary interface 700 displays the indication of each asset that is included in the data currently being displayed. For example, the asset summary interface 700 displays a cluster 710 that includes the indications of all assets. For illustrative purposes, a zoomed-in view of the cluster 710 is shown in FIG. 8. As can be seen, the cluster 710 includes indications of all assets. Each indication may be displayed in a particular format based on what asset bucket the asset is grouped into. For example, all assets grouped into an asset bucket for the asset type “office” may be displayed in purple. As another example, all assets grouped into an asset bucket for the asset type “retail” may be displayed in red. The total count of assets is displayed which in this example is 395 assets. The total GAV of all assets is also displayed which in this example is 98.8B.

Referring back to FIG. 7, the asset summary interface 700 displays a cluster 720 that includes the indications of all assets grouped into the asset bucket associated with San Francisco.

As another example, the asset summary interface 700 displays a cluster 730 that includes the indications of all assets grouped into the bucket associated with San Francisco and grouped into the sub-bucket associated with the asset type “office”. For illustrative purposes, a zoomed-in view of the cluster 730 is shown in FIG. 9. As can be seen, the cluster 730 includes indications of all assets grouped into the bucket associated with San Francisco and grouped into the sub-bucket associated with the asset type “office”. As mentioned, each indication may be displayed in a particular format based on what asset bucket the asset is grouped into. In this example, since all assets are grouped into the asset bucket associated with the asset type “office”, the indications are all displayed in purple. The total count of assets is displayed which in this example is 8 assets. The total GAV of all assets is also displayed which in this example is 4.4B.

Referring back to FIG. 7, the asset summary interface 700 includes a static image 740 which in this example includes a world map.

In one or more embodiments, the server computer system 120 may calculate at least one metric for each asset bucket and may overlay at least one interface element associated with the at least one metric on the static image. For example, the assets may be grouped into asset buckets by region. The server computer system 120 may calculate the total GAV for each asset bucket and as such the total GAV for each region may be determined. The server computer system 120 may generate an interface element for each asset bucket. The interface element may include a circular interface element that may be sized based on the total GAV percentage of that asset bucket.

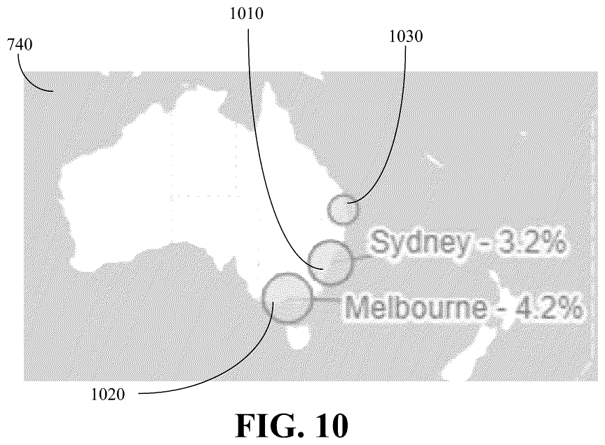

As mentioned, the interface elements may be overlaid on the static image. For illustrative purposes, a zoomed-in view of a portion of the static image 740 is shown in FIG. 10. In this example, an interface element 1010 is overlaid on the static image 740. The interface element 1010 is associated with an asset bucket for the region (or city) “Sydney” and is sized based on the total GAV percentage of the asset bucket. The total GAV percentage is displayed adjacent to the interface element 1010. Interface elements 1020 and 1030 are similarly displayed and are associated with asset buckets for the regions of Melbourne and Brisbane, respectively.

It will be appreciated that the asset summary interface 700 may include selectable interface elements that may be selected to zoom into a certain portion of the static image 740. For example, a user may wish to view all assets within a particular country or region and as such may manipulate the view of the static image 740 accordingly.

In manners described herein, the asset summary interface may display interface elements for one or more assets or asset buckets that are sized based on one or more calculated statistics and are displayed in a format based on what asset bucket the interface element is associated with. In this manner, the asset summary interface is able to provide a simple visual display of assets owned and this may allow an operator or user of the computing device 110 to easily view and compare the various assets.

Although in embodiments the assets are described as being obtained by the server computer system 120, it will be appreciated that in one or more embodiments the assets may be dynamically created or obtained by the server computer system 120. For example, a user may authenticate by providing authentication information such as for example a username and password. The authentication may provide access the asset management application. Once successful, the server computer system 120 may use the authentication information to autogenerate one or more asset summary interfaces described herein.

In one or more embodiments, assets may be autogenerated. For example, the server computer system 120 may engage an artificial intelligence engine that may include a generative artificial intelligence component. The generative artificial intelligence component may be trained or otherwise instructed to generate assets based on asset data received or otherwise obtained within the asset management application. For example, the generative artificial intelligence component may be trained using a large dataset comprised of data associated with a large number of assets. The dataset may be used to fine-tune a pre-existing neural network architecture through unsupervised learning, where the model is trained to utilize data associated with assets to group assets into asset buckets and to generate asset summary interfaces at least based on the asset buckets. In one or more embodiments, the generative artificial intelligence component may be trained to generate assets based on metadata and/or metatags extracted from the large data set. In this manner, the server computer system 120 may engage the artificial intelligence component to dynamically add assets within the asset management application.

The data obtained by the server computer system 120 described herein may additionally or alternatively be configured to provide a virtual real estate tour of all assets owned or partially owned within the one or more real estate funds. For example, the server computer system 120 may present a graphical user interface that includes a selectable option to virtually tour the assets. In response, the server computer system 120 may obtain data for a first asset and may present the data in a graphical user interface similar to that shown in FIG. 6. For example, the server computer system 120 may obtain an image of the first asset via an API using parameters stored in the database, similar to that described herein. The graphical user interface may also display statistics relating to the first asset and/or may display a map showing the physical location of the first asset. The graphical user interface may include a selectable option to view a next asset and in response the server computer system 120 may obtain data for a second asset and update the display accordingly. It will be appreciated that the virtual real estate tour may be for all assets or may be filtered to only tour assets within a particular asset bucket.

In one or more embodiments, the server computer system 120 may provide a data hub within the asset management application.

For example, in one or more embodiments, the server computer system 120 may obtain additional data associated with the plurality of assets and may generate one or more data files based thereon and these data files may be made available within the data hub. The additional data may include, for example, positions, rates, transaction data, pricing data, currency data, appraisal data, mortgage expenses, etc. For example, the server computer system 120 may obtain data associated with a particular asset from one or more APIs and/or third party servers. In one or more embodiments, the server computer system 120 may periodically communicate requests for the data and this may be done every day, week, month, quarter, year, etc. In one or more embodiments, the data may be obtained automatically. For example, one or more third party servers may be configured to communicate data periodically such as for example every day, week month, quarter, year, etc.

In response to obtaining the data associated with the particular asset, the server computer system 120 may analyze the data to generate one or more data files such as for example a balance sheet for the asset and this may be done according to one or more predefined rules. The balance sheet may include a list of costs, equities, liabilities, etc. associated with the asset. For example, the balance sheet may include amortization costs, build costs, land costs, leasing costs, market value adjustment, mortgage data, deferred charges, prepaid expenses, recoverable capital expenditures, rent, tenant account receivables, etc. The equities may include contributed surplus, notes payable to shareholders, retained earnings, shares/bonds, etc. The liabilities may include accounts payable, deferred revenue, mortgage payable, and other liabilities.

Once generated, the server computer system 120 may communicate the one or more data files to one or more computing devices. For example, within the asset summary application, a computing device may display a graphical user interface that includes data associated with a particular asset and at least one image associated with the asset. The graphical user interface may include a selectable option to receive data files associated with the asset. Once selected, the server computer system 120 may add an electronic address associated with the computing device or a user of the computing device, such as for example an email address, to a list in the database in association with the asset. Each time data is obtained, the server computer system 120 may update the data file and may send the updated data file to all electronic addresses associated with the asset.

The methods described above may be modified and/or operations of such methods combined to provide other methods.

Furthermore, the description above generally describes operations that may be performed by a server and a client device in cooperation with one another. Operations that are described as being performed by the server may, instead, be performed by the client device.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A server computer system comprising:
a communications module;
at least one processor coupled to the communications module; and
a memory coupled to the at least one processor and storing processor-executable instructions which, when executed by the at least one processor, configure the at least one processor to:
obtain data associated with a plurality of assets;
group the assets into one or more asset buckets;
within at least one of the asset buckets, identify at least one representative asset based at least on stored selection criteria;
obtain at least one image associated with the at least one representative asset; and
send, via the communications module and to a computing device, an asset summary interface that includes the at least one image associated with the at least one representative asset.

2. The server computer system of claim 1, wherein when obtaining the at least one image associated with the at least one representative asset, the processor-executable instructions which, when executed by the at least one processor, configure the at least one processor to:
generate an application programming interface request (API) for obtaining the at least one image associated with the at least one representative asset;
send, via the communications module and to an API endpoint, the API request for the at least one image associated with the at least one representative asset; and
receive, via the communications module and from the API endpoint, the at least one image associated with the at least one representative asset.

3. The server computer system of claim 2, wherein the API request defines at least one parameter for obtaining the at least one image associated with the at least one representative asset.

4. The server computer system of claim 3, wherein the at least one parameter includes at least one of a location, heading, pitch or image size.

5. The server computer system of claim 3, wherein the processor-executable instructions which, when executed by the at least one processor, configure the at least one processor to:
consult a database to retrieve the at least one parameter for obtaining the at least one image associated with the at least one representative asset, the database maintaining data records that store the data associated with the plurality of assets and associating each asset with at least one parameter for obtaining the at least one image associated with the asset.

6. The server computer system of claim 1, wherein the processor-executable instructions which, when executed by the at least one processor, configure the at least one processor to:
calculate at least one metric for each asset bucket; and
update the asset summary interface to include at least one interface element associated with the calculated at least one metric.

7. The server computer system of claim 6, wherein a size of the at least one interface element displayed on the asset summary interface is based on the calculated at least one metric.

8. The server computer system of claim 1, wherein the asset summary interface includes a static image and the processor-executable instructions which, when executed by the at least one processor, configure the at least one processor to:
calculate at least one metric for each asset bucket; and
overlay at least one interface element associated with the calculated at least one metric on the static image.

9. The server computer system of claim 1, wherein the asset summary interface displays at least one indication of each asset, the at least one indication displayed in a particular size based on at least one metric of the asset and in a particular format based on the asset bucket the asset is grouped into.

10. The server computer system of claim 1, wherein the processor-executable instructions which, when executed by the at least one processor, configure the at least one processor to:
engage a normalization engine to normalize the obtained data associated with the plurality of assets into a particular format.

11. A computer-implemented method comprising:
obtaining data associated with a plurality of assets;
grouping the assets into one or more asset buckets;
within at least one of the asset buckets, identifying at least one representative asset based at least on stored selection criteria;
obtaining at least one image associated with the at least one representative asset; and
sending, via a communications module and to a computing device, an asset summary interface that includes the at least one image associated with the at least one representative asset.

12. The computer-implemented method of claim 11, wherein when obtaining the at least one image associated with the at least one representative asset, the method further comprises:
generating an application programming interface request (API) for obtaining the at least one image associated with the at least one representative asset;
sending, via the communications module and to an API endpoint, the API request for the at least one image associated with the at least one representative asset; and
receiving, via the communications module and from the API endpoint, the at least one image associated with the at least one representative asset.

13. The computer-implemented method of claim 12, wherein the API request defines at least one parameter for obtaining the at least one image associated with the at least one representative asset.

14. The computer-implemented method of claim 13, wherein the at least one parameter includes at least one of a location, heading, pitch or image size.

15. The computer-implemented method of claim 13, further comprising:
consulting a database to retrieve the at least one parameter for obtaining the at least one image associated with the at least one representative asset, the database maintaining data records that store the data associated with the plurality of assets and associating each asset with the at least one parameter for obtaining the at least one image associated with the asset.

16. The computer-implemented method of claim 11, further comprising:
calculating at least one metric for each asset bucket; and
updating the asset summary interface to include at least one interface element associated with the calculated at least one metric.

17. The computer-implemented method of claim 16, wherein a size of the at least one interface element displayed on the asset summary interface is based on the calculated at least one metric.

18. The computer-implemented method of claim 11, wherein the asset summary interface includes a static image and the method further comprises:
calculating at least one metric for each asset bucket; and
overlaying at least one interface element associated with the calculated at least one metric on the static image.

19. (canceled)

20. A non-transitory computer readable medium having stored thereon processor-executable instructions which, when executed by at least one processor, configure the at least one processor to:
obtain data associated with a plurality of assets;
group the assets into one or more asset buckets;
within at least one of the asset buckets, identify at least one representative asset based at least on stored selection criteria;
obtain at least one image associated with the at least one representative asset; and
send, via a communications module and to a computing device, an asset summary interface that includes the at least one image associated with the at least one representative asset.

21. The server computer system of claim 1, wherein the plurality of assets includes one or more assets generated using an artificial intelligence engine trained on asset data.
